(19) United States
(12) Patent Application Publication
(10) Pub. No.: US 2025/0365131 A1
(43) Pub. Date: Nov. 27, 2025

(54) REVERSE DECOMPOSITION OF INTERMEDIATE VALUES IN CRYPTOGRAPHIC APPLICATIONS

(71) Applicant: Cryptography Research, Inc., San Jose, CA (US)

(72) Inventor: Michael Alexander Hamburg, Rosmalen (NL)

(21) Appl. No.: 19/213,297

(22) Filed: May 20, 2025

Related U.S. Application Data
(60) Provisional application No. 63/650,343, filed on May 21, 2024.

(51) Int. Cl. H04L 9/06

(52) U.S. Cl. CPC H04L 9/0643

(57) ABSTRACT

Disclosed aspects and implementations are directed to systems and techniques for efficient execution of post-quantum cryptographic applications and protection of cryptographic computations against side-channel attacks. In one example, techniques for performing a cryptographic operation include generating a first value and computing, by the processing device, a second value. A low part of the second value is mapped to a high part of a product of a public value and the first value and a high part of the second value is mapped to a low part of the product of the public value and the first value. The techniques further include computing, using the second value, an output of the cryptographic operation that includes a digital signature for an input into the cryptographic operation or a ciphertext encrypting the input into the cryptographic operation.

### CLAIM OF PRIORITY

The present application claims the benefit under 35 U.S.C. § 119(e) of U.S. Provisional Patent Application No. 63/650,343 filed May 21, 2024, which is incorporated by reference herein.

### TECHNICAL FIELD

Aspects of the present disclosure are directed to cryptographic computing applications, more specifically to protection of lattice-based post-quantum cryptographic applications from side-channel attacks.

### BRIEF DESCRIPTION OF THE DRAWINGS

The present disclosure will be understood more fully from the detailed description given below and from the accompanying drawings of various implementations of the disclosure.

FIG. 1 illustrates schematically operations that are used to generate digital signatures in Dilithium applications.

FIG. 2 illustrates schematically example operations that use a reverse decomposition for efficient computation of digital signatures in Dilithium applications, in accordance with one or more aspects of the present disclosure.

FIG. 3 illustrates operations of masked generation of digital signatures in Dilithium applications.

FIG. 4 illustrates example operations of masked generation of digital signatures with reverse decomposition in Dilithium applications, in accordance with one or more aspects of the present disclosure.

FIG. 5A illustrates an example computing architecture in which various implementations of the present disclosure may operate.

FIG. 5B illustrates another example computing architecture in which various implementations of the present disclosure may operate.

FIG. 6 is a block diagram illustrating an example computing platform capable of using reverse decomposition for efficient implementation of cryptographic applications, in accordance with one or more aspects of the present disclosure.

FIGS. 7A-7B depict flow diagrams of an example method of using reverse decomposition in cryptographic applications, in accordance with one or more aspects of the present disclosure.

FIG. 8 depicts a flow diagram of another example method of using reverse decomposition in cryptographic applications, in accordance with one or more aspects of the present disclosure.

FIG. 9 depicts a block diagram of an example computer system operating in accordance with one or more aspects of the present disclosure.

### DETAILED DESCRIPTION

In public-key cryptography systems, a processing device may have various components/modules used for cryptographic operations on input messages, which are typically represented via large integers. Cryptographic algorithms often involve modular arithmetic operations with modulus q, in which the set of all integers Z is wrapped around a circle of length q (the set Z_{q}), so that any two numbers that differ by q (or any other integer multiple of q) are congruent to (and treated as) the same number within Z_{q}. Pre-quantum cryptographic applications—such as the Rivest-Shamir-Adelman (RSA) algorithm, digital signature algorithms (DSA), Diffie-Hellman key exchange (DHKE) algorithms, Elliptic Curve Cryptography (ECC) algorithms, and the like-exploit the fact that solving an integer factorization problem, a discrete logarithm problem, an elliptic curve discrete logarithm problem, and/or the like, involves prohibitively difficult operations (for large moduli q) on a classical computer.

Progress in quantum computing technology has placed conventional public key encryption schemes into jeopardy. In response, in 2016, the National Institute of Standards and Technology (NIST) initiated a Post-Quantum Cryptography (PQC) standardization process to promote development of public-key cryptographic algorithms that are resistant against attacks using quantum computers. In July 2022, after rigorous analysis and evaluation, NIST has selected the following algorithms: CRYSTALS-DILITHIUM digital signatures algorithm, selected under the name ML-DSA (various versions of such algorithms referred to as “Dilithium” herein), CRYSTALS-KYBER key encapsulation mechanism, selected under the name ML-KEM (various versions of such algorithms referred to as “Kyber” herein), FALCON digital signatures algorithm, and SPHINCS+ hash-based signature algorithm. In particular, NIST recommended Dilithium as the primary signature algorithm. Additional key encapsulation algorithms are currently considered, including BIKE, Classic McEliece, and HQC. Further NIST competitions have been initiated for signature algorithms that are based on different mathematical foundations.

As an example, Dilithium algorithm is based on the Module-Learning-With-Errors (MLWE) problem on structured lattices with the underlying operations involving matrix-vector (and vector-vector) multiplications where the elements of the matrices/vectors are polynomials defined on a ring R_{q}=Z_{q}[x]/(xⁿ+1), namely polynomials with coefficients in Z_{q} and polynomial operations defined modulo the modulus polynomial xⁿ+1. Computations involved in message authentication in Dilithium applications are rather complex and require substantial processing and memory resources, and can be slow to perform on microprocessors and various low-resource devices, such as card readers, wireless sensor nodes, Internet-of-Things device, and/or the like.

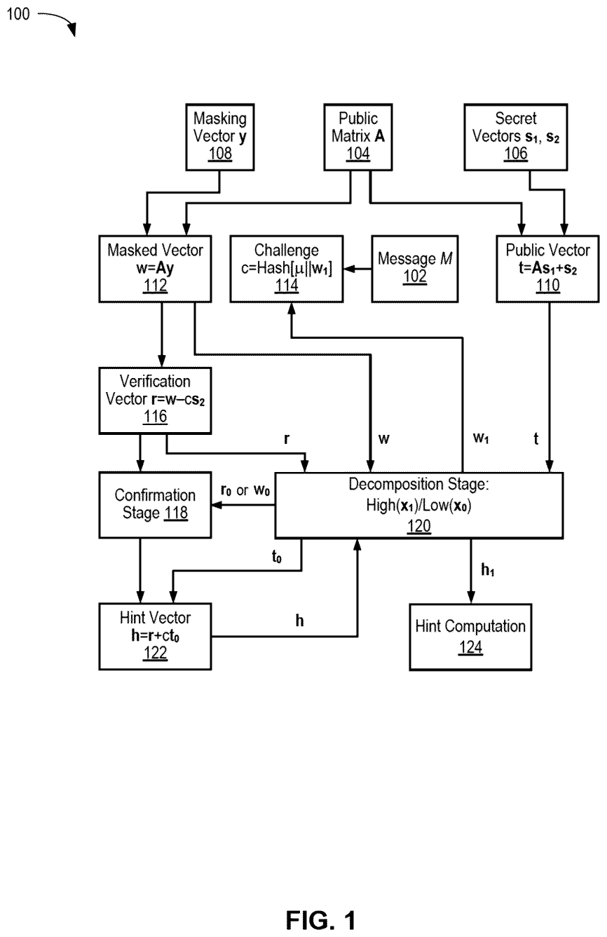

FIG. 1 illustrates schematically operations 100 that are used to generate digital signatures in Dilithium applications. Operations 100 can be performed to authenticate message M 102. Operations 100 include generating a public k×l matrix A 104 (whose elements can be generated from a public seed value using a pseudo-random number generator) and a set of secret vectors 106, a l×1 vector s₁ and a k×1 vector s₂, and another secret l×1 masking vector y 108. Elements of public matrix 104, secret vectors 106, and masking vector 108 are polynomials on the ring R_{q}. Coefficients of polynomials of masking vector 108 are selected to be small, e.g., smaller than a set parameter γ. This parameter γ is set to be large enough that the digital signature does not reveal the secret key (the signing algorithm is zero-knowledge) yet small enough so that the signature is not easily forged.

The public matrix 104 is used together with secret vectors 106 to generate a public vector t₀=As₁+s₂ 110, which together with public matrix 104 represents a public key that can be communicated over unsecured communication channels, e.g., to various devices that perform message verification. Masking vector 108 is used to mask the public matrix 104 by computing a masked vector w=Ay 110. The masked vector 110 can be represented via a low part w₀ and a high part w₁,

$$w ≡ {w}_{1} \cdot α + {w}_{0} ( mod q ) ,$$

where q is the modulus and significance α is an even integer that divides q−1 (for Dilithium, q−1=2²³−2¹³=8380416). Significance α depends on a particular version of the Dilithium, e.g.,

$$α = \frac{q - 1}{44} = 190464 ,$$

### for Dilithium-2 and

$$α = \frac{q - 1}{16} = 523776 ,$$

### for Dilithium-3 and Dilithium-5.

A decomposition stage 120 decomposes inputs x into the high part x₁ and the low part x₀. For example, the decomposition stage 120 can include a rounding division of an input x by a, which gives the high part x₁, followed by a computation of the low part x₀ using multiplication and subtraction, x₀=x−x₁·a.

The high part w₁ of masked vector 112, computed by the decomposition stage 120, is concatenated to a hash u computed using message 102 and used as an input into a hash function that computes a challenge c 114: c=Hash[μ∥w₁]. The value u is obtained by computing a hash of message M 102 with the public key (and/or a part of the public key). Challenge c is a polynomial in R_{q} with a fixed number of coefficients 1 (the rest of the coefficients being 0).

The masked vector 112 is used to compute a verification vector r=w−cs₂ 116. Prior to being revealed publicly, verification vector 116 remains secret until successful confirmation by a confirmation stage 118. Confirmation stage uses the low part r₀ of verification vector 116, computed by the decomposition stage 120. (Alternatively, operations of confirmation stage 118 can be performed using the low part w₀ of masked vector 116 that is combined with small term −cs₂.) If the absolute value any coefficient of r₀ is larger than or equal to α/2−β, where parameter β is the maximum possible coefficient of cs₁ and cs₂, the verification vector 116 is rejected and the signature process is restarted (by selecting a different masking vector 112). Similarly, the verification vector 116 is rejected if any coefficient of a signature vector z=y+cs₁ is larger than or equal to γ−β.

If the verification vector 116 is confirmed by the confirmation stage 118, the digital signature (e.g., the signature vector z and the challenge c) can be communicated to the receiving device together with message 102 that is being authenticated. The receiving device computes the high part r′₁ of the verification vector r′=Az−ct, concatenates the high part r′₁ to the received message, computes the hashed message u and verification challenge c′=Hash[μ∥r′₁], and compares the computed challenge c′ to the received challenge c. The message M is considered positively verified if c′=c and all coefficients of the signature vector z are larger than α/2−β. Even though the verification vector r′ is not exactly equal to the masked vector w, the difference w−r′=cs₂ is small (by construction) and only affects the low parts of the two vectors, so that r′₁=w₁ and, respectively, c′=c.

The Dilithium operations, as described above, are typically optimized using the fact that the high part r′₁ of the verification vector r′=Az−ct does not depend too much on the low part t₀ of t. The low part t₀ is, therefore, not included in the public key. To ensure that the receiving device is nonetheless able to compute the high part of r′=Az−ct correctly, the signing device includes hints as part of the signature, e.g., the carries caused by adding the product of c and the missing part t₀. More specifically, the signer computes a hint vector h=r+ct, 122, determines (using the decomposition stage 120) the high part h₁ of h and uses the high part h₁ to perform hint computation 124, namely determine bits of the high part h₁ that differ from bits r₁. (The bounds on ct₀ ensure that such bits cannot differ by more than 1.)

Operations 100 illustrated in FIG. 1 include multiple decompositions (of w, r, and h) that involve computationally expensive divisions. Since the significance α is not a power of 2 in Dilithium, such divisions cannot be performed economically, e.g., by bit shifting. Aspects and implementations of the present disclosure address these and other challenges of the post-quantum cryptographic technology by enabling systems and techniques that reduce processing and memory costs of digital signature and key encapsulation operations by using a reverse decomposition. More specifically, in the instances of Dilithium applications, intermediate vectors w, r, and h are replaced with vectors w̅, r̅, and h̅ in which the high parts and the low parts are substantially (up to uniform shifts) swapped with the new significance δ=(q−1)/α, e.g., δ=16 (for Dilithium-3 and Dilithium-5) or δ=44 (for Dilithium-2). For example, the high part w₁ of the masked vector w can then be computed as the low part w̅₀ of the reverse masked vector w̅, e.g., simply as w̅₀=w̅ mod δ. In the instances of Dilithium-3 and Dilithium-5, since δ=24, the computation of w̅₀ can be performed efficiently by bit shifting. The confirmation stage 118 may be performed without any decomposition of r̅ since comparison of the high part r̅₁ of the reverse verification vector r (which is mapped to the low part r₀ of r) to appropriate bounds can be performed based on the reverse verification vector r̅ directly because (as disclosed in more detail below) the low part r̅₀ does not affect the result of such a comparison. Furthermore, the hints can be computed based on the low bits of h̅, which can be efficiently performed with XOR (modulo 2 addition)

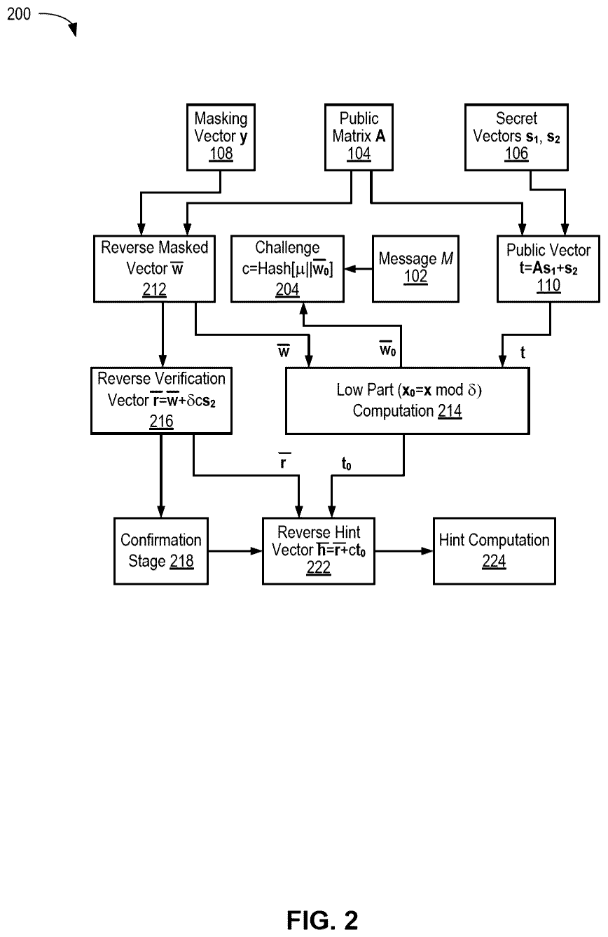

FIG. 2 illustrates schematically example operations 200 that use a reverse decomposition for efficient computation of digital signatures in Dilithium applications, in accordance with one or more aspects of the present disclosure. As illustrated, operations 200 may include using public matrix 104 and secret vectors 106 to compute public vector 110 and may further include computing a reverse masked vector w̅ 212 using masking vector y 108. Elements of public matrix 104, secret vectors 106, and masking vector 108, and reverse masked vector 212 may be polynomials on the ring R_{q}. Reverse masked vector w̅ 212 may be mapped on masked vector w 112 of operations 100 but differ from masked vector 112 in the arrangement of its high and low parts.

In some implementations, significance δ=(q−1)/α≡−α⁻¹ (mod q) may be defined. Reverse masked vector w̅ 212 may then be computed from the masked vector w̅ 112 as follows:

$$\overline{w} = ( \frac{α}{2} - w ) \cdot δ mod q = ( \frac{α}{2} - {w}_{0} - {w}_{1} \cdot α ) \cdot δ mod q = ( \frac{α}{2} - {w}_{0} ) \cdot δ + {w}_{1} mod q ,$$

where by construction, α·δ mod q≡−1. Since −α/2<w₀≤α/2, the term (α/2−w₀)·δ is non-negative and at most (α−1)·δ=q−1−δ. Because by construction 0≤w₁<δ, the sum of the two contributions in the expression for w̅ is less than q. Therefore, the masked vector w̅ 212 is mapped to the masked vector w 112 with the high part w₁ of vector w mapped to low part w̅₀ of vector w̅,

$${\overline{w}}_{0} = {w}_{1} ,$$

and the low part w₀ of vector w mapped to the high part w̅₁ of vector w̅,

$${\overline{w}}_{1} = \frac{α}{2} - {w}_{0} .$$

Accordingly, the low and the high parts of the masked vector w 112 may be computed as

$${w}_{1} = \overline{w} mod δ ,$$

$${w}_{0} = \frac{α}{2} - ⌊ \frac{\overline{w}}{δ} ⌋ ,$$

where the brackets └.┘ indicate the rounding-down operation.

In implementations that use reverse masked vector w 212 and reverse decomposition, the low part w̅₀ of reverse masked vector 212 may be used in lieu of the high part w₁ of masked vector 112 to compute challenge c: c=Hash[M∥w̅₀]. The low part w₀ may be efficiently computed, by low part computation 214, as w̅₁=w̅ mod δ. In those implementations where δ is a power of 2, e.g., δ=2ⁿ, the low part w̅₁ is simply given by the least-significant n bits of reverse masked vector w̅ 212.

The reverse masked vector 212 may be used to compute a reverse verification vector r̅=w̅+δcs₂ 216. As the reverse masked vector w̅ 212 is not used again in operations 200, the reverse verification vector 216 may overwrite reverse masked vector w̅ 212 in a register (or some other memory device) where w̅ was stored. Operations of confirmation stage 218 may be performed directly on reverse verification vector r̅ 216. More specifically, the condition that r₀ (understood as any coefficient in the corresponding vector r₀ of polynomials) is within the bounds,

$$β - α / 2 < - {r}_{0} < α / 2 - β ,$$

may be equivalently written as

$$β - α / 2 < ⌊ \frac{\overline{r} - ( q - 1 ) / 2}{δ} ⌋ < α / 2 - β ,$$

$$or$$

$$( β - α / 2 + 1 ) \cdot δ \leq \overline{r} - ( q - 1 ) / 2 < ( α / 2 - β ) \cdot δ ,$$

or, equivalently,

$$( β + 1 ) \cdot δ \leq \overline{r} < q - 1 - β \cdot δ ,$$

Thus, the checks of the confirmation stage 218 can be performed directly using verification vector r̅ 216 without using the low part w₀ of masked vector 112. Confirmation stage 218 may further confirm that ∥ct₀∥_{∞}<α/2. (This check may be unnecessary for some Dilithium versions, e.g., Dilithium-3 and Dilithium-5, where this check cannot fail.)

If reverse verification vector 216 passes the checks of the confirmation stage 218, it remains to verify whether the high part r₁≡r̅ mod δ of the verification vector r 116 equals the high part h₁ of the hint vector h=r+ct₀ 122. Up to a certain (determined by the Dilithium specification) number ω of mismatched bits can be tolerated. The locations of such mismatched bits may be recorded as hints as part of hint computation 224. Since ∥ct₀∥œ<α/2, the high parts r₁ and h₁ cannot differ by more than 1 in any coefficient. The high part of the hint vector 122 can be computed as h₁=h̅ mod δ, where reversed hint vector h̅ 222 is computed as h̅=(r̅−δ·c·t₀) mod q. After computation of the reverse hint vector h̅, the reverse verification vector r̅ 212 is not used again in operations 200, so the reverse hint vector may overwrite the reverse verification vector in the memory storage, for more efficient memory utilization. In some implementations, hint computation 224 may be performed one (or several) coefficients of reverse hint vector h̅ and reverse verification vector r̅ at a time. After identification of the respective hint bits, the respective coefficients may be overwritten, e.g., by the hint bits.

Since in each coefficient, h₁ and w₁≡r̅ mod δ differ by at most 1 and the modulus δ is even, the difference h₁−w₁ is given by the XOR operation of the lowest bits of h̅ and r̅:r̅±h̅=r̅[0]⊕h̅[0], where the addition or subtraction is performed over the integers with no reduction mod q. This approach, which involves checking one bit of the coefficients of the two polynomials r̅ and h̅, is more efficient than the conventional approach in the Dilithium specification that requires a more complex bounding operation. Furthermore, calculation of the reverse hint vector 222 according to the disclosed techniques can be accelerated in the instances of δ=2ⁿ, where scaling of c·t₀ by δ in the calculation of h̅ can be performed by bit-shifting towards more significant bits by n bits.

The disclosed techniques of performing Dilithium computations are substantially more efficient when implemented in terms of reverse vectors w̅, r̅, and h̅. Certain operations, e.g., mod q arithmetic operations, may be supported with dedicated hardware circuits, e.g., bit-shifters, and/or other dedicated circuits.

Alternatively, the low and the high parts of the masked vector w 112 may be computed using rounding division and modulo operations using an intermediate value defined as

$$\tilde{w} = - w \cdot {δmod}^{\pm } q$$

in which the expression x mod^{±} q denotes the residue congruent to x modulo q, which has the least absolute value. In this alternative method, \tilde{w} can be used to compute

$${w}_{1} = \tilde{w} mod δ ,$$

$${w}_{0} = - ⌊ \frac{\tilde{w}}{δ} ⌋ .$$

The techniques disclosed above in conjunction with FIG. 2 may also be performed using \tilde{w} in lieu of w̅. More specifically, the low part of \tilde{w} may be used in computation of challenge 204, the reverse verification vector 216 may be computed as \tilde{r}=\tilde{w}+δcs₂, with the computation stage 218 performed using \tilde{r} directly, without decomposition. Likewise, hint computation 224 may be performed using reverse hint vector computed as, \tilde{h}=\tilde{r}+ct₀.

Similar techniques may be deployed with other LWE cryptographic applications, e.g., applications that use the Kyber key encapsulation mechanism. Kyber applications include a key generation stage, an encryption (encapsulation) stage, and a decryption (decapsulation) stage. The key generation stage generates a public matrix A, a secret vector s, and a small error vector e to generate a public vector t=As+e. The encryption stage encrypts a (polynomial) message m, using the public key (A, t), by generating a vector of random polynomials y and computing a (polynomial) vector u=A^{T}y+e₁ and a (polynomial) value v=t^{T}y+e₂+m, where e₁ and e₂ are small random errors. The combination (u, v) is the ciphertext that encrypts message m. The decryption stage includes recovering message m, using the secret vector s, by computing the noisy message mₙ=v−s^{T}u≡m+ey+e₂−s^{T}e₁. Message m is then recovered by rounding up the noisy message mₙ, which eliminates the noise contributions ey+e₂−s^{T}e₁. In Kyber applications, a Compress function is often used to discard a number of low bits of the public vector t and ciphertext (u, v) that do not affect the correctness of decryption. The decryption stage uses a matching Decompress function.

Kyber's Compress function works similarly to Dilithium's decomposition. To compress an input x to d bits, Compress function computes the rounding operation modulo 2^{d}:

$$Compress ( x , d ) = ⌊ x \cdot {2}^{d} / q ⌉ mod {2}^{d} , = \frac{x \cdot {2}^{d} - ( x \cdot {2}^{d} mod q )}{q} mod {2}^{d} = - \frac{x \cdot {2}^{d} mod q}{q} mod {2}^{d}$$

This expression may be computed using the lowest d bits of the reverse input x̅=((q−1)/2−x·2^{d})mod q:

$$Compress ( x , d ) = ( \overline{x} - \frac{q - 1}{2} ) \cdot {q}^{- 1} mod {2}^{d} .$$

In some implementations, the ciphertext value v may be compressed to four (d=4) or five (d=5) digits. For Kyber, q−1=13·2⁸; because (q−1)/2 mod 2^{d}=0 and q⁻¹≡1 mod 2^{d}, so that Compress function may be efficiently computed as d lowest bits of the reverse ciphertext value v̅:

$$Compress ( v , d ) = \overline{v} mod {2}^{d} ≡ \overline{v} [ d - 1 , ... 1 , 0 ] .$$

The ciphertext vector u may be compressed to ten (d=10) or eleven (d=11) digits, in which case the reverse input x≡ū is computed. Since in these instances q⁻¹≠1 mod 2^{d}, all terms in Compress(u, d) are computed.

Although confidential data encrypted using Dilithium, Kyber, and/or other similar polynomial-based cryptographic techniques may be well protected from unauthorized accesses while in the ciphertext form, a weak security link exists on a sender's or a recipient's side, where a private key may be exposed to a side-channel attack. For example, during a decryption stage, a series of known (public) ciphertexts is multiplied by the same secret vector (e.g., the private key or other secret data derived from the private key). As the same secret data is multiplied over and over by varying and known (to the attacker) ciphertexts, the secret data may be compromised. During a side-channel attack, an attacker monitors signals (e.g., acoustic, electrical, magnetic, optical, thermal, etc.) produced by electronic circuits of the targeted computer during operations with the secret data. By recording and correlating processor (and/or memory) activity with computations carried out by the targeted computer, an attacker can reveal the secret data. A simple power analysis (SPA) side-channel attack examines electrical power used by the device as a function of time. As presence of noise hides the signal of the processor/memory, a more sophisticated differential power analysis (DPA) attack can use statistical analysis of power measurements performed over multiple cryptographic operations (or multiple iterations of a single cryptographic operation). An attacker employing DPA may filter out the noise component of the power signal (using the fact that the noise components may be uncorrelated between different operations or iterations of the same operation) to extract the component of the signal that is representative of the actual processor activity and to infer the value of the secret data from this signal, thus gaining access to the secret data (e.g., private key).

Protection against side-channel attacks includes various masking techniques. For example, arithmetic masking protects secret data x by randomly splitting the secret data into multiple arithmetic shares x₁, . . . , x_{M} that add up (e.g., modulo some number q) to the secret data

$$x = {x}_{1} + ... + {x}_{M} ( mod q ) ,$$

and performing cryptographic operations with the shares individually such that the secret data x is not revealed directly to the potential attacker. Boolean masking protects secret data x by using Boolean operations, such as bitwise XOR additions, to randomly split the secret data into Boolean shares ξ₁, . . . ξ_{N} that add up to the secret data

$$x = {ξ}_{1} ⊕ ... ⊕ {ξ}_{N} ,$$

and performing cryptographic operations with the shares individually such that the secret data x is not revealed directly to the potential attacker.

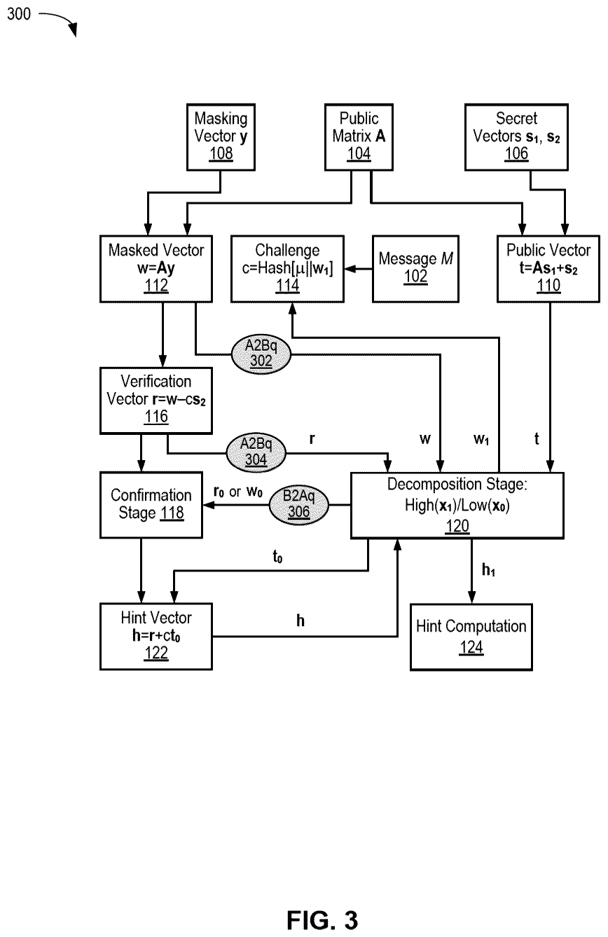

FIG. 3 illustrates operations 300 of masked generation of digital signatures in Dilithium applications. In masked generation, masked vector w 112 is initially represented via arithmetic shares. To perform decomposition into a low part w₀ and a high part w₁, the masked vector 112 undergoes an arithmetic-to-Boolean modulo q (A2Bq) conversion 302, in which arithmetic shares w₁, . . . w_{M} are converted into Boolean shares ω₁, . . . ω_{N}, with the rounding division of the decomposition stage 120 performed on the Boolean shares. Following the decomposition stage 120, the high part w₁ is used (still expressed via the corresponding Boolean shares) for the challenge 114 computation. Similarly, the low part r₀ of verification vector r 116 is computed by converting, using A2Bq conversion 304, arithmetic shares of verification vector r 116 into its Boolean shares. After decomposition, the Boolean shares of the low part r₀ of verification vector r 116 undergo a reverse Boolean-to-arithmetic modulo q (B2Aq) conversion 306 to arithmetic shares, which are used in the confirmation stage 118 to confirm that the coefficients of the low part r₀ are within the prescribed bounds. Alternatively, after A2Bq conversion 304 is performed to obtain verification vector r 116 in the Boolean-masked form, followed by a rounding division operation to compute the high part r₁ and the operation compute the low part r₀=r−r₁·α in the Boolean masked form. The confirmation stage 118 is then performed using the low part r₀ in Boolean-masked form.

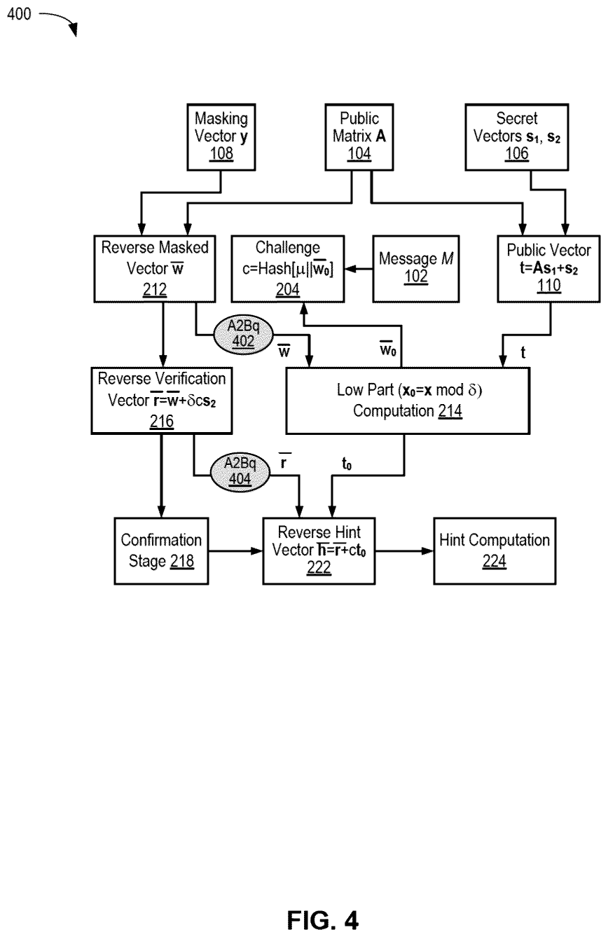

FIG. 4 illustrates example operations 400 of masked generation of digital signatures with reverse decomposition in Dilithium applications, in accordance with one or more aspects of the present disclosure. Unlike operations 300, example operations 400 use one or two A2Bq conversions. More specifically, masked vector w=Ay may be calculated, e.g., using a linear Number Theoretic Transform (NTT), separately for separate arithmetic shares of masking vector y 108. The computation of reverse masked vector w̅ 212 is likewise a linear operation, w̅=(α/2−w)·δ mod q, which may also be performed on separate arithmetic shares. Moreover, the linear nature of both the NTT and the reverse masked vector computation makes it possible to combine the factor δ with NTT scaling factor(s). Arithmetic shares of the reverse masked vector 212 may then be converted, using A2Bq conversion 402, to the corresponding Boolean shares followed by low part computation 214 of w̅₀, performed in the Boolean masked form. The Boolean shares of w̅₀ may then be used for the computation of the challenge 204. Operations of computation of reverse verification vector r̅ 216 and confirmation stage 218 may be performed using arithmetic shares. Provided that the confirmation stage 218 confirms that r̅ is within the prescribed bounds (meaning that the value r̅ is at no risk of revealing secret data), obtaining the reverse hint vector h̅ 222 and performing hint computation 224 may be done without masking. In some implementations, operations of the confirmation stage 218 may be performed using reverse verification vector r̅ 216 in Boolean-masked form obtained be A2Bq conversion 404.

The confirmation stage 218, as disclosed above, involves checking the bounds on various components F of reverse verification vector r̅ 216:

$$( β + 1 ) \cdot δ \leq \overline{r} < q - 1 - β \cdot δ .$$

In some implementations, the value (β+1)·δ may be subtracted from one of the shares of r̅; the bounds check may then amount to:

$$( \overline{r} - ( β + 1 ) \cdot δ ) mod q < q - 1 - ( 2 \cdot β + 1 ) \cdot δ .$$

This bounds check may be performed by applying A2B conversion to the left-hand side (r̅−(β+1)·δ) mod q, subtracting the right-hand side and then checking the sign of the result; if the result is negative, then r̅ is within the prescribed bounds. The sign bit may be safe to reveal as it is safe to reveal which specific coefficient r̅ of the reverse verification vector r̅ 216 exceeds the bounds, as long as the specific amount of the excess is not revealed.

In the instances of Dilithium-2 applications, where δ=44, masked vector w may be computed in the conventional (non-reversed) form, then extract and hash w₁ before converting w to the reverse vector r̅ for the remainder of the calculation.

Similar masking techniques may be deployed in Kyber applications. In the Kyber encryption (encapsulation) stage, the compression modulus is a power of two, δ=2^{d} The output of Compress(u, d)=(ū−(q−1)/2)·q⁻¹ mod 2^{d} does not reduce to u mod 2^{d}. (On the other hand, the result of Compress(v, d)=v̅ mod 2^{d}, since q⁻¹=1 mod 2^{d}) Because q and q⁻¹ mod 2^{d} have low hamming weights, the multiplication by q−1 may be performed efficiently using shifts and masked additions. In some implementations, multiplication by q−1 may not have to be performed since Compress(u, d) is an invertible function of ū mod 2^{d}. Because the values Compress(u, d) and ū mod 2^{d} are public, so is ū mod 2^{d}. Therefore once ū mod 2^{d} has been extracted, one may subtract (q−1)/2 and multiply by q⁻¹ mod d on the unmasked form.

The Kyber decryption (decapsulation) stage includes a re-encryption test, in which the decryptor checks that the encryption was performed correctly—that is, whether re-encrypting the recovered plaintext gives the same ciphertext (c₁, c₂) that was received. This re-encryption includes checking whether Compress(u, d)=? c₁ and Compress(v, d)=? c₂. Since the values Compress(u, d) and Compress(v, d) are secret, in side-channel-protected implementations, it may be preferable to minimize the amount of computation on these secret values. In some implementations, instead of checking

$$Compress ( u , d ) = ( \overline{u} - ( q - 1 ) / 2 ) \cdot {q}^{- 1} mod {2}^{d} = ? {c}_{1} ,$$

a processing device implementing the Kyber computation may check whether

$$\overline{u} mod {2}^{d} = ? {c}_{1} \cdot q + \frac{q - 1}{2} mod {2}^{d} .$$

Here the right-hand side is public and does not need to be masked. This manipulation may be omitted for comparing Compress(v, d), because for that calculation q⁻¹≡1 mod 2^{d}.

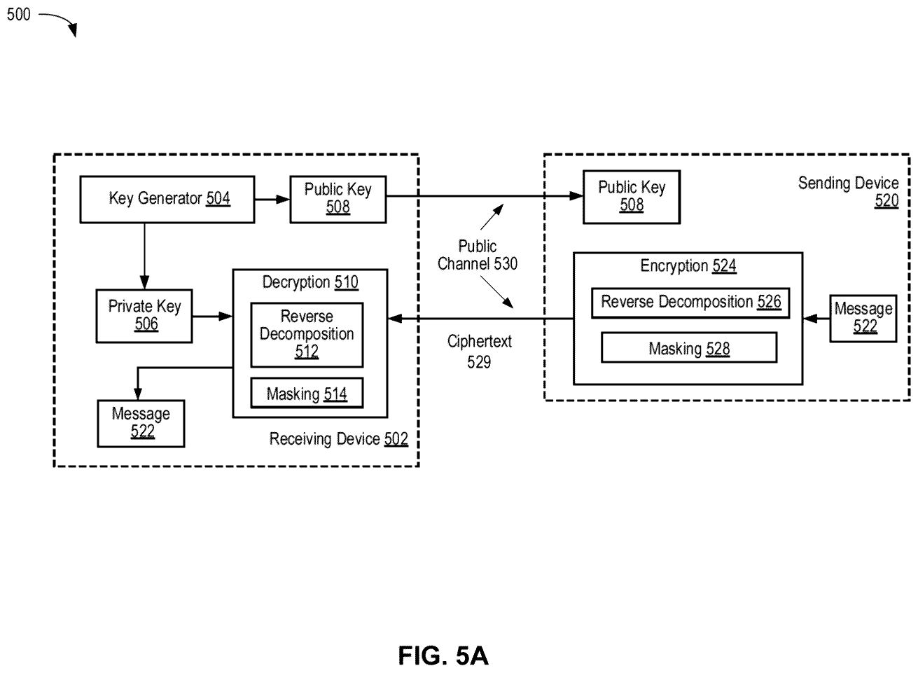

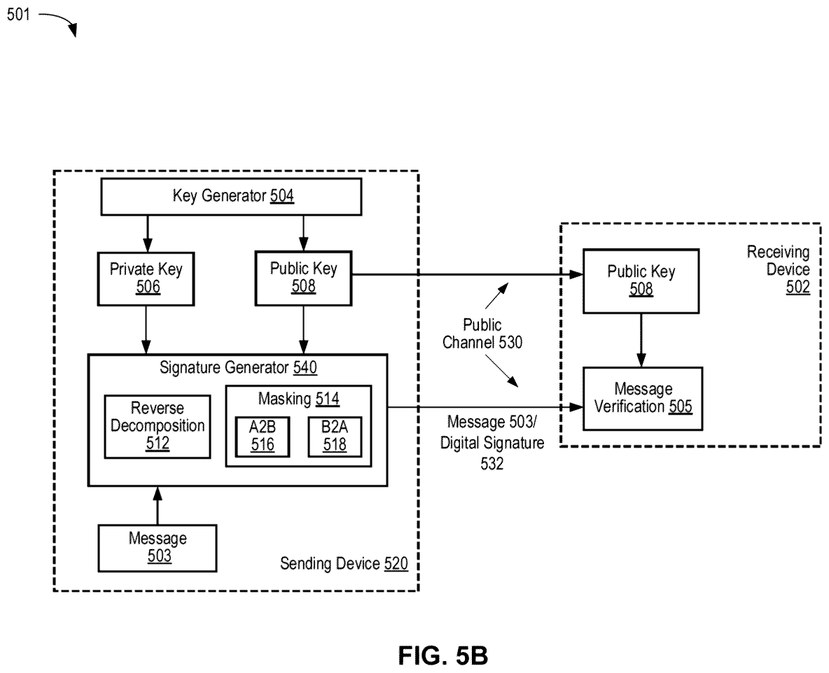

FIG. 5A illustrates an example computing architecture 500 in which various implementations of the present disclosure may operate. In some implementations, computing architecture 500 implements public/private key cryptographic applications, Kyber key encapsulation applications, and/or other cryptographic applications. Computing architecture 500 may include various components/modules/applications that are not explicitly depicted in FIG. 5A, including but not limited to various domain-specific applications that perform operations on output or input messages. Computing architecture 500 may include a receiving device 502 deploying a cryptographic application-specific key generator 504 that may generate a private key 506 and a public key 508. Receiving device 502 may provide public key 508 to a sending device 520 that uses public key 508 to encrypt a message 522 before sending ciphertext (encrypted message) 529 over a public communication channel 530, which may include any network, e.g., Internet, local area network, wide area network, and/or the like. In some implementations, message 522 may encapsulate a symmetric key provided to receiving device 502 to establish secure communication between receiving device 502 and sending device 520 over public communication channel 530. Message 522 may be encrypted by an encryption module 524 implementing a suitable encryption scheme. In some implementations, the encryption scheme may be one of the post-quantum encryption schemes, including but not limited to Kyber, and/or other similar algorithms.

As disclosed above in conjunction with FIGS. 1A-1B and FIGS. 2A-2B, encryption stage 524 may include reverse decomposition logic 526 that decomposes various values x, e.g., inputs and intermediate outputs, processed by the encryption stage 524 into a low part x₀ and a high part x₁ by operating with a reverse value x̅ whose low part x̅₀ and high part x₁ are mapped to the opposite parts of the original values: x̅₀=x̅₀(x₁) and x̅₁=x̅₁(x₀). In some implementations, encryption stage 524 may include a masking module 528 that represents various secret values (e.g., message 522, random polynomials that are used to generate ciphertexts, and/or the like) via multiple arithmetic and/or Boolean shares with operations of the encryption stage 524 performed directly on the shares without revealing the secret data (the sum of the shares). This protects the secret data from side-channel attacks during encryption of message(s) 522.

Receiving device 502 may process the received ciphertext 529 using decryption stage 510 and recover message 522 using private key 506. Decryption stage 510 may also include reverse decomposition logic 512 that operates similar to reverse decomposition logic 526 of the encryption stage 524 by substantially reversing the low and high parts of various inputs and intermediate outputs of the decryption stage 510 and deploying a masking module 514 to protect secret data (e.g., private key 506, message 522, and/or the like) against side-channel attacks using arithmetic and/or Boolean shares. Although, for illustration, ciphertext(s) and plaintext(s) (decrypted messages) are generated/processed by different devices in the illustration of FIG. 5A, in some instances ciphertext(s) and plaintext(s) may be generated/processed by the same device. For example, sending device 520 may be the same device as receiving device 502.

FIG. 5B illustrates another example computing architecture 501 in which various implementations of the present disclosure may operate. Computing architecture 501 may implement message authentication using digital signature algorithms, e.g., Dilithium digital signature algorithms, and/or other cryptographic applications. As illustrated in FIG. 5B, sending device 520 may deploy key generator 504 that generates private key 506 and public key 508. Sending device 520 may provide public key 508 to receiving device 502. Sending device 520 may include a signature generator 540 that authenticates message 503 using private key 506 or a combination of private key 506 and public key 508. In some implementations, signature generator 540 may include reverse decomposition logic 512 that operates similarly to the reverse decomposition logic of FIG. 5A, e.g., by substantially reversing low and high parts of various inputs and intermediate outputs processed by signature generator 540. Signature generator 540 may also include a masking module 514 to protect secret data (e.g., private key 506, message 503, and/or the like) against side-channel attacks using arithmetic and/or Boolean shares. Masking module 514 may include an arithmetic-to-Boolean (A2B) conversion 516 to convert arithmetic shares to Boolean shares and a Boolean-to-arithmetic (B2A) conversion 518 to convert Boolean shares to arithmetic shares.

Sending device 520 may send message 503 together with digital signature 532 produced by signature generator 540 to receiving device 502 over public communication channel 530. Receiving device 502 may use public key 508 to perform message verification 505 to verify digital signature 532. In some implementations, the digital signature scheme may be one of the post-quantum digital signature schemes, including but not limited to Dilithium, and/or the like. Although, in the illustration of FIG. 5B different devices perform a signature generation and verification, in some instances both algorithms may be performed by the same device (e.g., with sending device 520 being the same as receiving device 502).

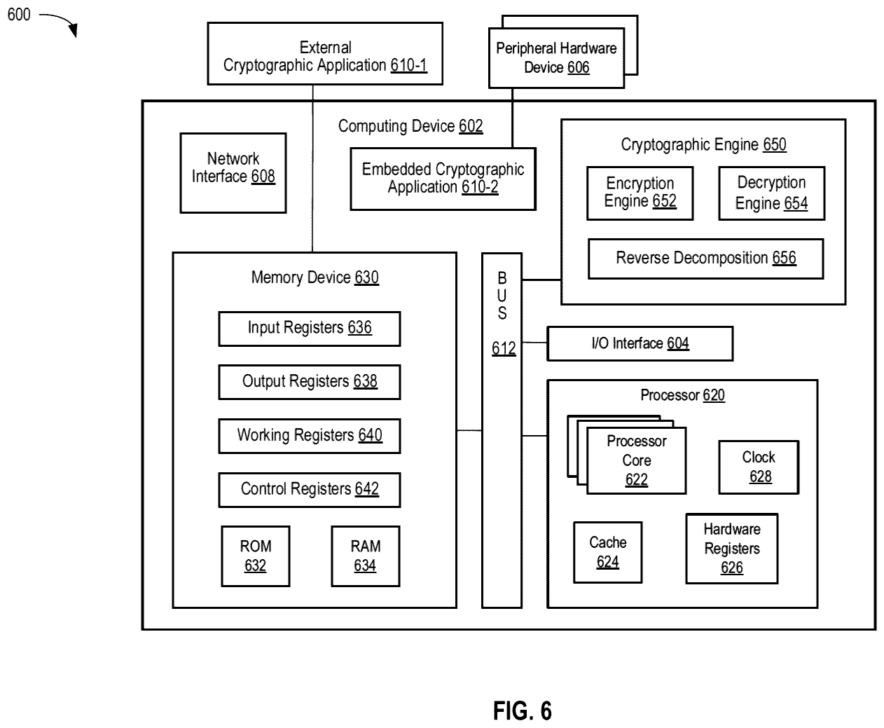

FIG. 6 is a block diagram illustrating an example computing platform 600 capable of using reverse decomposition for efficient implementation of cryptographic applications, in accordance with one or more aspects of the present disclosure. Example computing device 600 may be or include a desktop computer, a tablet, a smartphone, a server (local or remote), a thin/lean client, and the like. Example computing platform 600 may be a smart card reader, a wireless sensor node, an embedded system dedicated to one or more specific applications (e.g., cryptographic applications 610-n), and so on. Example computing platform 600 may include (but need not be limited to) a computing device 602 having one or more processors 620 (e.g., central processing units (CPUs)) capable of executing binary instructions, and one or more memory devices 630. Herein “processor” or “processing device” refers to a device capable of executing instructions encoding arithmetic, logical, or I/O operations. In one illustrative example, a processing device may follow von Neumann architectural model and may include an arithmetic logic unit (ALU), a control unit, and a plurality of registers. A processing device may be a single-core processor capable of executing one instruction at a time (or process a single pipeline of instructions), or a multi-core processor capable of simultaneous execution of multiple instructions. A processing device may be implemented as a single integrated circuit, two or more integrated circuits, or may be a component of a multi-chip module. A processing device may be or include a CPU, a graphics processing unit (GPU), a field-programmable gate array (FPGA), an application-specific integrated circuit (ASIC), or any combination thereof.

Computing device 602 may include an input/output (I/O) interface 604 to facilitate connection of computing device 602 with peripheral hardware devices 606, such as card readers, terminals, printers, scanners, internet-of-things devices, and the like. Computing device 602 may further include a network interface 608 to facilitate connection to a variety of networks (Internet, wireless local area networks (WLAN), personal area networks (PAN), public networks, private networks, etc.), and may include a radio front end module and other devices (amplifiers, digital-to-analog and analog-to-digital converters, dedicated logic units, etc.) to implement data transfer to/from the computing device 602. For example, network interface 608 may be used to support a connection to sending device 520 of FIGS. 5A-5B. Various hardware components of computing device 602 may be connected via a bus 612, which may have its own logic circuits.

Example computing platform 600 may support one or more cryptographic applications 610-n, such as one or more external cryptographic applications 610-1 and/or one or more embedded cryptographic applications 610-2. Cryptographic applications 610-n may be secure authentication applications, public key signature applications, key encapsulation applications, key decapsulation applications, encryption applications, decryption applications, fully homomorphic encryption/decryption applications, secure storage applications, and so on. External cryptographic application 610-1 may be instantiated on the same computing device 602, e.g., by an operating system executed by the processor 620 and residing in a memory device 630. Alternatively, external cryptographic application 610-1 may be instantiated by a guest operating system supported by a virtual machine monitor (hypervisor) executed by the processor 620. In some implementations, external cryptographic application 610-1 may reside on a remote access client device or a remote server (not shown), with the computer device 602 providing cryptographic support for the client device and/or the remote server.

Processor 620 may include one or more processor cores 622 having access to cache 624 (e.g., a single-level or multi-level cache) and one or more hardware registers 626. In some implementations, each processor core 622 may execute instructions to run a number of hardware threads, also known as logical processors. Various logical processors (or processor cores) may be assigned to one or more cryptographic applications 610-n, although more than one processor may be assigned to a single cryptographic application for parallel processing. Memory device 630 may refer to a volatile or non-volatile memory and may include a read-only memory (ROM) 632, a random-access memory (RAM) 634, as well as (not shown) electrically erasable programmable read-only memory (EEPROM), flash memory, flip-flop memory, or any other device capable of storing data. RAM 634 may be a dynamic random access memory (DRAM), synchronous DRAM (SDRAM), a static memory, such as static random access memory (SRAM), and the like.

Memory device 630 may include one or more registers, such as one or more input registers 636 to store cryptographic keys, input polynomials, and other data for cryptographic applications 610-n. Memory device 630 may further include one or more output registers 638 to store outputs of cryptographic application, and one or more working registers 640 to store various intermediate values generated in the course of performing cryptographic computations, including masking operations. Memory device 630 may also include one or more control registers 642 for storing information about modes of operation, selecting a cryptographic algorithm, initializing cryptographic computations, selecting a masking mode, selecting ring Z_{q}, performing masking and reverse decomposition, and/or the like. Control registers 642 may communicate with one or more processor cores 622 and a clock 628, which may keep track of a processing operation (e.g., iteration of the NTT/inverse NTT) being performed. In some implementations, registers 636-642 may be implemented as part of RAM 634. In some implementations, some or all of the registers 636-642 may be implemented separately from RAM 634. Some of or all registers 636-642 may be implemented as part of processor 620 (e.g., as part of the hardware registers 626). In some implementations, processor 620 and memory device 630 may be implemented as a single field-programmable gate array (FPGA).

Computing device 602 may include a cryptographic engine 650 to support cryptographic operations of processor 620. Cryptographic engine 650 may be configured to perform digital signature operations, key encapsulation operations, and/or any other applicable cryptographic operations, in accordance with implementations of the present disclosure. As depicted in FIG. 6, cryptographic engine 650 may be a separate hardware component, e.g., an accelerator. In some implementations, cryptographic engine 650 may be implemented as a software (or firmware) module instantiated in memory device 630. In some implementations, cryptographic engine 650 may be partially implemented as a hardware component and partially as a software (or firmware) module. Cryptographic engine 650 may include an encryption engine 652 to encrypt plaintext messages and generate ciphertexts. Cryptographic engine 650 may also include a decryption engine 654 to decrypt ciphertexts and recover plaintext messages. Encryption engine 652 and/or decryption engine 654 may use reverse decomposition 656 for efficient implementation of cryptographic applications, e.g., as described in more detail in conjunction with FIGS. 1A-1B and FIGS. 2A-2B above.

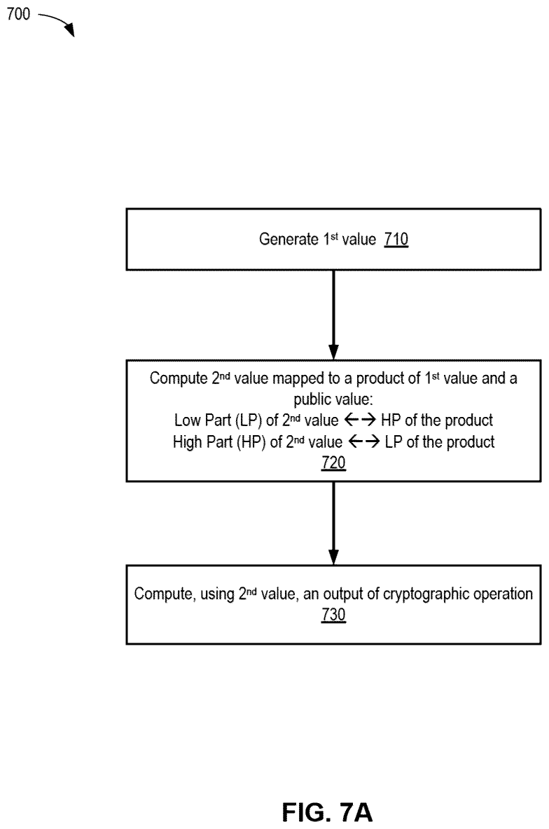

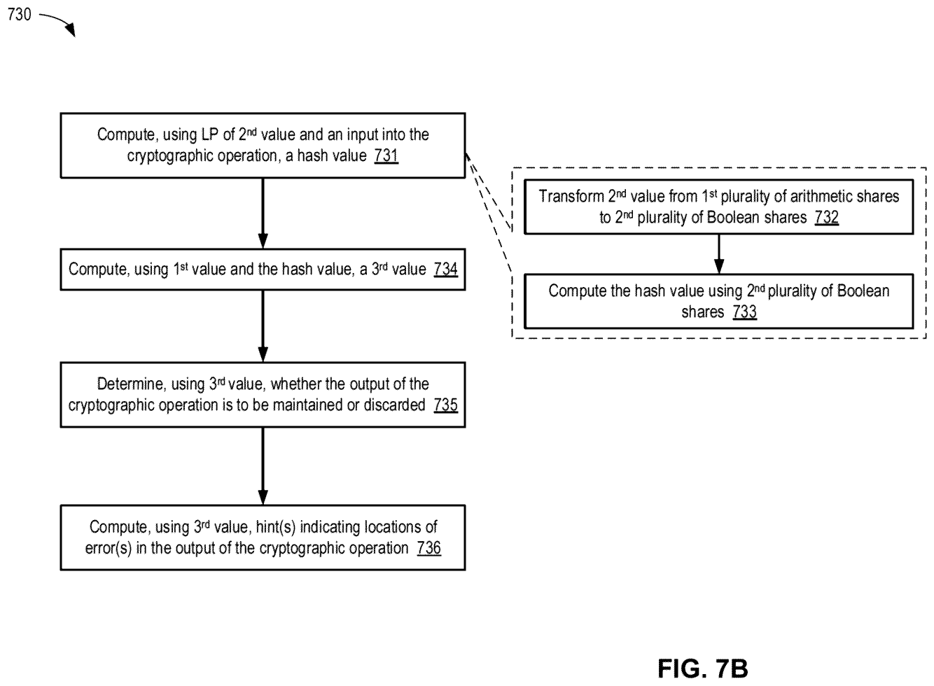

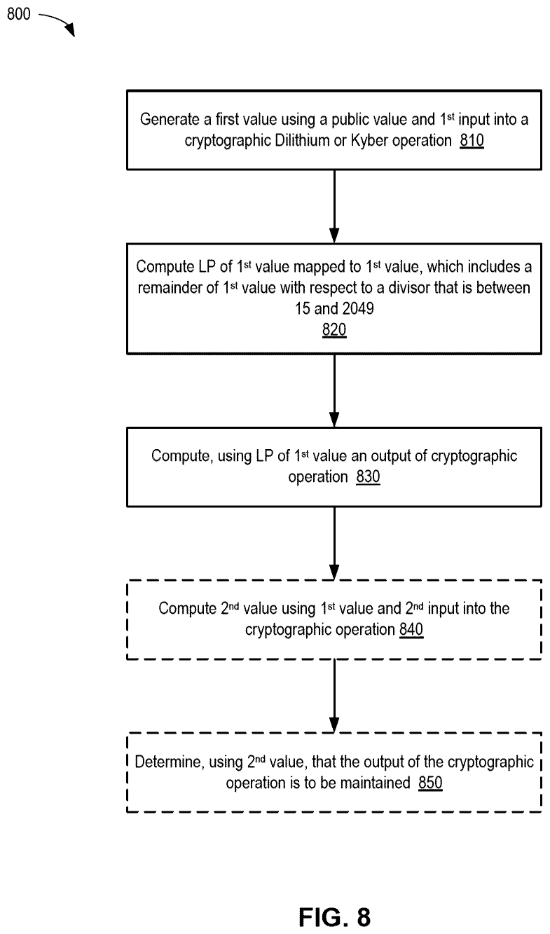

Methods 700 and/or 800 disclosed below in conjunction with FIGS. 7A-7B and/or FIG. 8, and/or each of its individual functions, routines, subroutines, or operations may be performed by one or more processing units of a suitable computing system, e.g., by processor 620 and/or cryptographic engine 650 of computing device 602 in FIG. 6. In some implementations, methods 700 and/or 800 may be performed by an arithmetic logic unit, an FPGA, an ASIC, a cryptographic accelerator, a dedicated hardware circuit, and the like, or any suitable processing logic, hardware or software or a combination thereof. In certain implementations, methods 700 and/or 800 may be performed by a single processing thread. Alternatively, methods 700 and/or 800 may be performed by two or more processing threads, each thread executing one or more individual functions, routines, subroutines, or operations of the method. In an illustrative example, the processing threads implementing methods 700 and/or 800 may be synchronized (e.g., using semaphores, critical sections, and/or other thread synchronization mechanisms). Alternatively, the processing threads implementing methods 700 and/or 800 may be executed asynchronously with respect to each other. Various operations of methods 700 and/or 800 may be performed in a different order compared with the order shown in FIGS. 7A-7B. Some blocks of method 700 may be performed concurrently with other blocks. Some blocks of method 700 may be optional.

FIGS. 7A-7B depict flow diagrams of an example method 700 of using reverse decomposition in cryptographic applications, in accordance with one or more aspects of the present disclosure. In some implementations, as illustrated in FIG. 7A, method 700 may include, at block 710, generating a first value. In some implementations, the first value may be a vector whose elements are polynomials aₙ₋₁xⁿ⁻¹+ . . . +a₁x+a₀. In some implementations, the polynomial may have n=256 coefficients aⱼ (e.g., in Dilithium and/or Kyber applications) having values aⱼ=0 or aⱼ=1. In some implementations, the first value includes a random value (e.g., y).

At block 720, method 700 may include computing, by the processing device, a second value w̅. The second value may be mapped, by a reverse mapping, to a product value (e.g., w=Ay) that includes a product of a public value and the first value. In some implementations, the public value includes a public matrix (e.g., matrix A) associated with at least one of a Dilithium digital signature generation or a Kyber key encapsulation mechanism.

The reverse mapping may map the low part of the second value to the high part of the product value, w̅₀↔w₁, and may further map a high part of the second value to the low part of the product value, w̅₁↔w₀. In some implementations, the product value w may be explicitly computed. In some implementations, the product value w is not computed and the first value—having the reverse mapping property described above—may be computed directly from y. The product value w may include a high part w₁ and a low part w₀. In some implementations, the high part w₁ of the product value w is a rounded quotient of the product value w with respect to a first divisor α, and the low part w₀ of the product value w is a remainder of the product value w with respect to the first divisor α (e.g., w=w₁·α+w₀).

In some implementations, the second value w̅=w̅₁·δ+w₀, and the high part w̅₁ of the second value is a rounded quotient of the second value w̅ with respect to a second divisor δ, while the low part w̅₀ of the second value is a remainder of the second value w with respect to the second divisor δ. In some implementations, the second divisor is a ratio of (i) a decremented, by unity, modulus q of the cryptographic operation and (ii) the first divisor: δ=(q−1)/α.

In some implementations, the low part of the second value corresponds to the high part of the product value, w̅₀=w₁, and the high part of the second value corresponds to a difference between a reference value and the high part of the first value, w̅₁=α/2−w₀. In some implementations, the reference value equals one half of the first divisor, α/2.

At block 730, method 700 may continue with computing, by the processing device and using at least the low part of the second value, an output of the cryptographic operation. The output of the cryptographic operation may include a digital signature for an input into the cryptographic operation (e.g., digital signature for a message m, in the instances of Dilithium cryptographic applications), a ciphertext encrypting the input into the cryptographic operation (e.g., ciphertext (u, v), in the instances of Kyber cryptographic applications).

In some implementations, block 730 may include one or more operations depicted in FIG. 7B. More specifically, at block 731, method 700 may include computing, using the low part of the second value (e.g., w̅₀) and the input into the cryptographic operation (e.g., message m), a hash value (e.g., challenge c 204 in FIG. 2). In some implementations, the second value is represented by a plurality of shares, e.g., arithmetic shares and/or Boolean shares. Each share of the second value may correspond to a respective share of the product value (e.g., w=Ay) or a respective share of the first value (e.g., y). As illustrated with the callout portion of FIG. 7B, computing the hash value may include, at block 732, transforming the second value from a first plurality of arithmetic shares to a second plurality of Boolean shares. At block 733, the hash value may be computed using the second plurality of Boolean shares.

In some implementations, method 700 may include, at block 734, computing, using the second value (e.g., w̅), a third value (e.g., r̅). At block 735, method 700 may include determining, using the third value, whether the output of the cryptographic operation is to be maintained or discarded. For example, operations of block 735 may include verifying whether the third value (or various components and/or coefficients of the third value) is within predetermined bounds.

In some implementations, at block 736, method 700 may include computing, using the third value, one or more hints indicating locations of one or more errors in the output of the cryptographic operation (e.g., as disclosed in conjunction with hint computation 224 of FIG. 2).

In some implementations, e.g., in Kyber applications, multiple reverse mappings may be used for a given cryptographic operation. For example, the first value may be a value v=t^{T}y+e₂+m and operations of block 720 may compute a second (reverse-mapped) value v. Computing the output of the cryptographic operation may include performing, using the second value, a first modulo 2^{d} arithmetic computation (e.g., Compress(v,d)=v̅ mod 2^{d} operation) to obtain a first portion of the output of the cryptographic operation. In the first modulo 2^{d} arithmetic computation, d may be a first number of bits (e.g., d=4 or 5) of the low part of the second value. In such implementations, method 700 may further include generating a third value, e.g., a vector u=A^{T}y+e₁ and computing a fourth value, e.g., ū, with a low part ū₀ of the fourth value mapped to a high part u₁ of the third value u and a high part ū₁ of the fourth value is mapped to a low part u₀ of the third value. Computing the output of the cryptographic operation may then include performing, using the fourth value, a second modulo 2^{D} arithmetic computation to obtain a second portion of the output of the cryptographic operation. In the second modulo 2^{D} arithmetic computation, D may be a second number of bits (e.g., D=10 or 11) of the low part of the fourth value.

FIG. 8 depicts a flow diagram of another example method 800 of using reverse decomposition in cryptographic applications, in accordance with one or more aspects of the present disclosure. At block 810, method 800 can include generating, by a processing device, a first value (e.g., reverse masked vector w̅). The first value can be generated using (i) a public value (e.g., a public matrix A) and (ii) a first input into a cryptographic operation (e.g., y). The cryptographic operation may include a Dilithium digital signature operation, a Kyber key encapsulation mechanism operation, and/or the like.

At block 820, method 800 can continue with computing, by the processing device, a low part of the first value (e.g., w̅₀ in the instances of the Dilithium digital signature operation or v̅ or ū, in the instances of the Kyber key encapsulation mechanism operation). In some implementations, the low part of the first value can include a remainder of the first value with respect to a first divisor. In some implementations, the first divisor can be between 15 and 2049. For example, in case of the Dilithium digital signature operation, the first divisor can be 16, 44, and/or the like. In case of the Kyber key encapsulation mechanism operation, the first divisor can be 16, 32 (e.g., when the first value includes v̅) or 2¹⁰=1024 or 2¹¹=2048 (e.g., when the first value includes ū).

At block 830, method 800 can include computing, by the processing device and using the low part of the first value, an output of the cryptographic operation (e.g., challenge value c, in case of the Dilithium digital signature operation or compressed combination (u, v), in case of the Kyber key encapsulation mechanism operation).

In some implementations, computing the output of the cryptographic operation includes operations of blocks 840 and 850. More specifically, at block 840, method 800 may include computing, using the first value and a second input into the cryptographic operation (e.g., message M), a second value (e.g., reverse verification vector r). At block 850, method 800 may include determining, using the second value, that the output of the cryptographic operation is to be maintained (or that the output of the cryptographic operation is to be discarded).

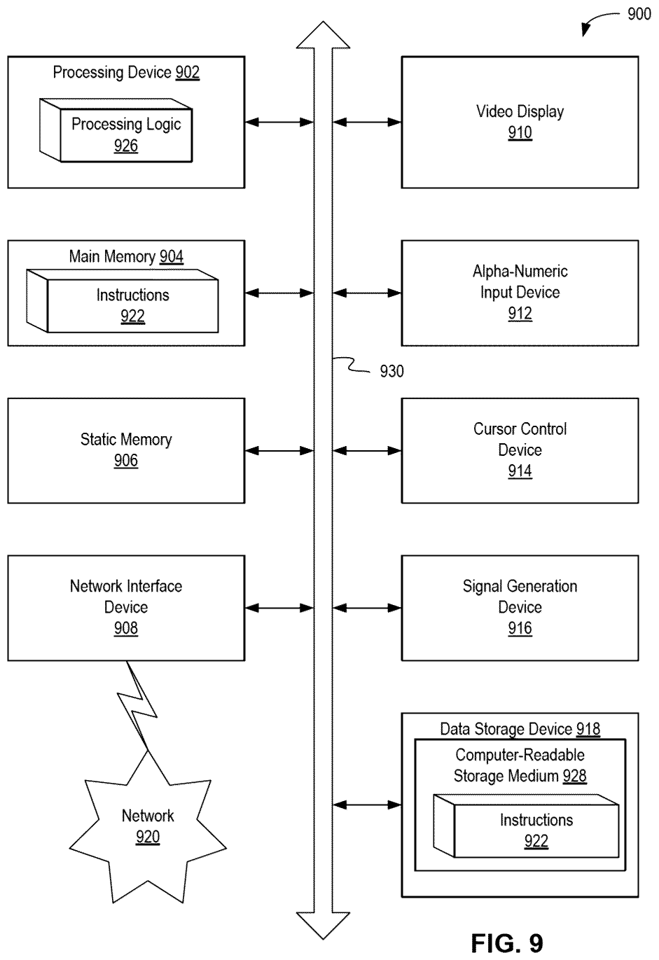

FIG. 9 depicts a block diagram of an example computer system 900 operating in accordance with one or more aspects of the present disclosure. In various illustrative examples, computer system 900 may represent computing device 602, illustrated in FIG. 6. Example computer system 900 may be connected to other computer systems in a LAN, an intranet, an extranet, and/or the Internet. Computer system 900 may operate in the capacity of a server in a client-server network environment. Computer system 900 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 900 may include a processing device 902 (also referred to as a processor or CPU), which may include processing logic 926, a main memory 904 (e.g., read-only memory (ROM), flash memory, dynamic random access memory (DRAM) such as synchronous DRAM (SDRAM), etc.), a static memory 906 (e.g., flash memory, static random access memory (SRAM), etc.), and a secondary memory (e.g., a data storage device 918), which may communicate with each other via a bus 930.

Processing device 902 represents one or more general-purpose processing devices such as a microprocessor, central processing unit, or the like. More particularly, processing device 902 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 902 may be configured to execute instructions implementing example methods 700 and/or 800 of using reverse decomposition in cryptographic applications.

Example computer system 900 may further comprise a network interface device 908, which may be communicatively coupled to a network 920. Example computer system 900 may further comprise a video display 910 (e.g., a liquid crystal display (LCD), a touch screen, or a cathode ray tube (CRT)), an alphanumeric input device 912 (e.g., a keyboard), a cursor control device 914 (e.g., a mouse), and an acoustic signal generation device 916 (e.g., a speaker).

Data storage device 918 may include a computer-readable storage medium (or, more specifically, a non-transitory computer-readable storage medium) 928 on which is stored one or more sets of executable instructions 922. In accordance with one or more aspects of the present disclosure, executable instructions 922 may comprise executable instructions implementing example methods 700 and/or 800 of using reverse decomposition in cryptographic applications.

Executable instructions 922 may also reside, completely or at least partially, within main memory 904 and/or within processing device 902 during execution thereof by example computer system 900, main memory 904 and processing device 902 also constituting computer-readable storage media. Executable instructions 922 may further be transmitted or received over a network via network interface device 908.

While the computer-readable storage medium 928 is shown in FIG. 9 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method to perform a cryptographic operation, the method comprising:
generating, by a processing device, a first value;
computing, by the processing device, a second value, wherein:
a low part of the second value is mapped to a high part of a product value, wherein the product value comprises a multiplication product of a public value and the first value, and
a high part of the second value is mapped to a low part of the product value; and
computing, by the processing device and using the second value, an output of the cryptographic operation, wherein the output of the cryptographic operation comprises at least one of:
a digital signature for an input into the cryptographic operation, or
a ciphertext encrypting the input into the cryptographic operation.

2. The method of claim 1, wherein the first value comprises a random value and the public value comprises a public matrix associated with at least one of a Dilithium digital signature generation or a Kyber key encapsulation mechanism.

3. The method of claim 2, wherein the random value comprises secret vector.

4. The method of claim 1, wherein the second value is represented by a plurality of shares.

5. The method of claim 1, wherein computing the output of the cryptographic operation comprises:
computing, using the low part of the second value and the input into the cryptographic operation, a hash value; and
computing, using the hash value, the output of the cryptographic operation.

6. The method of claim 5, wherein computing the hash value comprises:
transforming the second value from a first plurality of arithmetic shares to a second plurality of Boolean shares; and
computing the hash value using the second plurality of Boolean shares.

7. The method of claim 5, wherein computing the hash value comprises:
computing, using the second value and the hash value, a third value; and
determining, using the third value, whether the output of the cryptographic operation is to be maintained or discarded.

8. The method of claim 7, wherein determining whether the output of the cryptographic operation is to be maintained or discarded comprises:
computing, using the third value, one or more hints indicating locations of one or more errors in the output of the cryptographic operation.

9. The method of claim 1, wherein the high part of the product value is a rounded quotient of the product value with respect to a first divisor, and wherein the low part of the product value is a remainder of the product value with respect to the first divisor.

10. The method of claim 9, wherein the high part of the second value is a rounded quotient of the second value with respect to a second divisor, wherein the low part of the second value is a remainder of the second value with respect to the second divisor, and wherein the second divisor is a ratio of (i) a decremented, by unity, modulus of the cryptographic operation and (ii) the first divisor.

11. The method of claim 1, wherein the low part of the second value equals the high part of the product value.

12. The method of claim 1, wherein the high part of the second value corresponds to a difference between a reference value and the high part of the product value.

13. The method of claim 1, wherein computing the output of the cryptographic operation comprises performing, using the second value, a first modulo 2^{d} arithmetic computation to obtain a first portion of the output of the cryptographic operation, wherein dis a first number of bits of the low part of the second value.

14. The method of claim 13, further comprising:
generating a third value;
computing a fourth value, wherein:
a low part of the fourth value is mapped to a high part of the third value, and
a high part of the fourth value is mapped to a low part of the third value; and
wherein computing the output of the cryptographic operation further comprises performing, using the fourth value, a second modulo 2^{D} arithmetic computation to obtain a second portion of the output of the cryptographic operation, wherein D is a second number of bits of the low part of the fourth value.

15. A method comprising:
generating, by a processing device, a first value, wherein the first value is generated using (i) a public value and (ii) a first input into a cryptographic operation, wherein the cryptographic operation comprises at least one of:
a Dilithium digital signature operation, or
a Kyber key encapsulation mechanism operation;
computing, by the processing device, a low part of the first value, wherein the low part of the first value comprises a remainder of the first value with respect to a first divisor, wherein the first divisor is between 15 and 2049; and
computing, by the processing device and using the low part of the first value, an output of the cryptographic operation.

16. The method of claim 15, wherein computing the output of the cryptographic operation comprises:
computing, using the first value and a second input into the cryptographic operation, a second value; and
determining, using the second value, that the output of the cryptographic operation is to be maintained.

17. A processing device comprising:
one or more registers to store a first value associated with a cryptographic operation; and
one or more processing units communicatively coupled to the one or more registers, the one or more processing units to:
compute a second value, wherein:
a low part of the second value is mapped to a high part of a product value, wherein the product value comprises a multiplication product of a public value and the first value, and
a high part of the second value is mapped to a low part of the product value;
compute, by the processing device and using the second value, an output of the cryptographic operation, wherein the output of the cryptographic operation comprises at least one of:
a digital signature for an input into the cryptographic operation, or
a ciphertext encrypting the input into the cryptographic operation.

18. The processing device of claim 17, wherein the first value comprises a random value and the public value comprises a public matrix associated with at least one of a Dilithium digital signature generation or a Kyber key encapsulation mechanism.

19. The processing device of claim 17, wherein to compute the output of the cryptographic operation, the one or more processing units are to:
compute, using the low part of the second value and the input into the cryptographic operation, a hash value; and
compute, using the hash value, the output of the cryptographic operation.

20. The processing device of claim 19, wherein to compute the output of the cryptographic operation, the one or more processing units are to:
compute, using the second value and the hash value, a third value; and
determine, using the third value, whether the output of the cryptographic operation is to be maintained or discarded.
